(19) United States
(12) Patent Application Publication
(10) Pub. No.: US 2024/0345975 A1
(43) Pub. Date: Oct. 17, 2024

(54) TEST EQUIPMENT HUB

(71) Applicant: Future Dial, Inc., Sunnyvale, CA (US)

(72) Inventors: Jisheng Li, Los Altos, CA (US); Chen Chen, San Ramon, CA (US); Yueting Zhang, San Jose, CA (US)

(21) Appl. No.: 18/301,182

(22) Filed: Apr. 14, 2023

(51) Int. Cl. G06F 13/40

(52) U.S. Cl. CPC G06F 13/4027; G06F 2213/0024; G06F 2213/0042

(57) ABSTRACT

A device may include a housing. A device may include a plurality of universal serial bus (USB) ports configured to be connected to a plurality of devices under test. The plurality of USB ports is configured be connected to a connector in groups of two. The respective connectors are configured to be connected to a peripheral communication interface (PCI) bridge.

### FIELD OF THE TECHNOLOGY

At least some embodiments disclosed herein relate generally to test equipment. More specifically, at least some embodiments relate to a multi-port hub for connecting a plurality of devices under test to a computer system.

### BACKGROUND

Computing devices can be returned and refurbished for resale. It is important that a refurbished device pass a variety of tests to confirm the refurbished device is acceptable for resale. Processing time is an important consideration so that as many computing devices as possible can be tested and confirmed. Bottlenecks in the testing process can impact an overall duration of the process and subsequently, an overall value to the tester.

### BRIEF DESCRIPTION OF THE DRAWINGS

References are made to the accompanying drawings that form a part of this disclosure and illustrate embodiments in which systems and methods described in this Specification can be practiced.

FIG. 1 shows a test system, according to some embodiments.

FIG. 2 shows a test system, according to some embodiments.

FIG. 3 shows the hub device, according to some embodiments.

FIG. 4 is a block diagram illustrating an internal architecture of an example of a computer, according to some embodiments.

Like reference numbers represent the same or similar parts throughout.

### DETAILED DESCRIPTION

Computing devices can be returned and refurbished for resale. It is important that a refurbished computing device pass a variety of tests to confirm the refurbished computing device is acceptable for resale (e.g., in good working condition). It is possible for test equipment used in the testing process to limit a throughput of devices under test (e.g., a candidate computing device for refurbishment). Such limitations can result in reduced number of devices tested and, as such, a reduced number of computing devices available for resale.

For example, a test device (e.g., a computer system or the like) can be connected to a hub device (e.g., a universal serial bus (USB) hub device or the like). The hub device can then be connected to a plurality of devices under test. In some cases, the hub device can include seven (7) ports to receive up to seven devices under test at one time. Seven port hubs may have a limited bandwidth for each port. For example, in some seven port USB hub devices, a bandwidth of each port is on average 68 megabits per second (Mbps). In some cases, the hub device can include twenty (20) ports to receive up to twenty devices under test at one time. Twenty port hubs may have a limited bandwidth for each port. For example, in some twenty port USB hub devices, a bandwidth of each port is on average 48 Mbps. As a result, testing durations of the connected devices under test can slow the testing process. In some cases, the limited bandwidth can result in timeout failures as well as communication bus busy errors.

Embodiments of this disclosure relate to improved hub devices. In some embodiments, hub devices according to the present disclosure can include forty (40) ports. In some embodiments, each port on the hub devices includes an average bandwidth of 240 Mbps. In some embodiments, the hub devices of the present disclosure can increase the number of ports available to connect devices under test and can increase a bandwidth of each port compared to prior hub devices. In some embodiments, the hub devices of the present disclosure can increase a throughput of devices under test. For example, in some embodiments, a throughput of devices under test can be measured in units per hour (UPH). In some embodiments, an improvement in the UPH using the hub devices described herein can be from 80-200 UPH. In some embodiments, the improvement in the UPH can be more than 200 UPH.

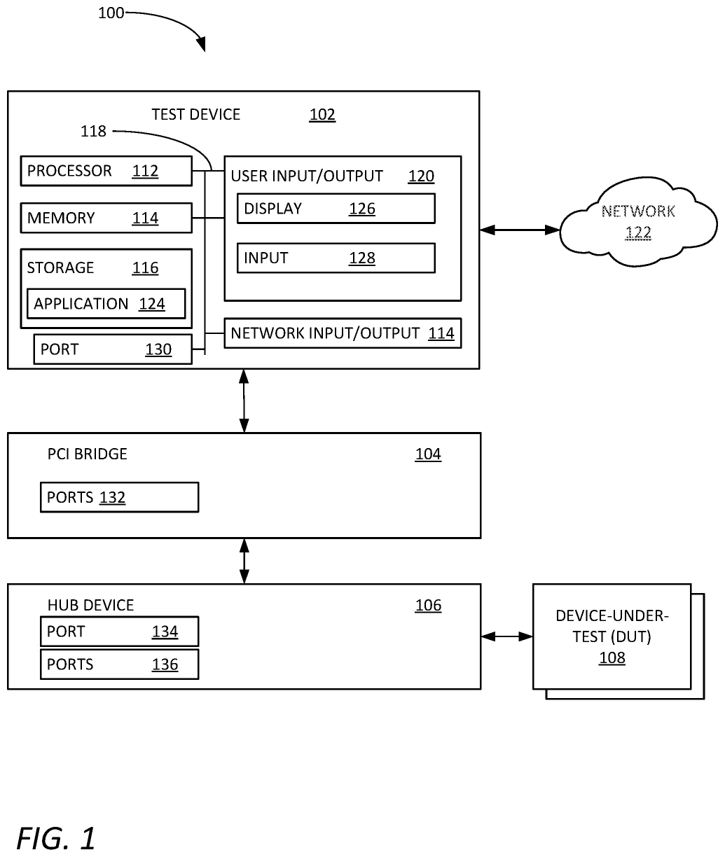

FIG. 1 shows a test system 100, according to some embodiments. The test system 100 can be used to, for example, run one or more diagnostic tests on a computing device (e.g., a device-under-test (DUT)). The system 100 can generally be used to investigate, receive, or otherwise operate on a plurality of DUTs. In some embodiments, investigating includes testing. Examples of investigating or otherwise operating on the plurality of DUTs can include, for example, data removal, device testing, or device inspection. Types of tests can include, for example, functional tests for the DUT. These types of tests and investigations can be useful in the process of refurbishing computing devices.

In some embodiments, the test system 100 includes a test device 102, a PCI bridge 104, a hub device 106, and a plurality of DUTs 108.

The test device 102 is configured to run various operations on the one or more DUTs 108 that are connected to the hub device 106. The test device 102 can alternatively be referred to as a computing system or the like.

The test device 102 includes a processor 110, a memory 112, a network input/output 114, a storage 116, an interconnect 118, and a user input/output 120. The test device 102 can be in communication with at least one additional test device 102 through a network 122.

The processor 110 can retrieve and execute programming instructions that are stored in the memory 112, the storage 116, or combinations of the memory 112 and the storage 116. For example, the storage 116 can include an application 124. The application 124 can, when executed, cause the processor 110 to perform a method to remove all data from the DUT and return the DUT to its factory settings. In an embodiment, the application 124 can, when executed, cause the processor 110 to perform a method to test a functionality of the DUT. The processor 110 can also store and retrieve application data residing in the memory 112. The interconnect 118 transmits programming instructions, application data, or combinations thereof, between the processor 110, the user input/output 120, the memory 112, the storage 116, and the network input/output 114. The interconnect 118 can be one or more busses or the like. The processor 110 can be a single processor, multiple processors, or a single processor having multiple processing cores. In an embodiment, the processor 110 is a single-threaded processor. In an embodiment, the processor 110 is a multi-threaded processor.

The user input/output 120 includes a display 126 and an input 128. In an embodiment, the display 126 and the input 128 are combined (e.g., a touchscreen interface). In an embodiment, the input 128 can include a variety of input devices suitable for receiving an input from the user. Examples of suitable devices include, but are not limited to, keyboard, a voice command, a proximity sensor, an ocular sensing device for determining an input based on eye movements (e.g., scrolling based on an eye movement), or the like. The user can provide information about the devices under investigation to the test device 102 via the input 128 and can receive instructions via the display 126. For example, the display 126 can display an instruction for an operator to take an action on one of the devices under investigation. In an embodiment, the display 126 could display a question to the operator such as, but not limited to, whether the DUT has any cracks or defects and the user can input a response via the input 128.

The memory 112 is generally included to be representative of a random access memory (RAM) such as, but not limited to, Static Random Access Memory (SRAM), Dynamic Random Access Memory (DRAM), or Flash. In some embodiments, the memory 112 can be a volatile memory. In some embodiments, the memory 112 can be a non-volatile memory. In some embodiments, at least a portion of the memory can be virtual memory.

The storage 116 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. The storage 116 can be a computer readable medium. In an embodiment, the storage 116 can include storage that is external to the computer device 10, such as in a cloud.

The network input/output 114 is configured to transmit data via the network 122. The network 122 may be referred to as the communications network 122. Examples of the network 122 include, but are not limited to, a local area network (LAN), a wide area network (WAN), the Internet, or the like. The network input/output 114 can transmit data via the network 122 through a wireless connection using Wi-Fi, Bluetooth, or other similar wireless communication protocols. The test device 102 can transmit data via the network 122 through a cellular, 3G, 4G, 5G, or other wireless protocol.

The memory 112 can store instructions for performing a variety of tests on the plurality of DUTs 108. In some embodiments, the processor 110 can cause the test device 102 to perform one or more tests on the plurality of DUTs 108. The test device 102 includes at least one port 130. In some embodiments, the at least one port 130 can include at least one peripheral component interconnect (PCI) standard port, at least one PCI express (PCIe) port, combinations thereof, or the like. In some embodiments, the PCI port can be configured to receive a PCI card, a PCIe card, such as the PCI bridge 104.

In some embodiments, the PCI bridge 104 can be a PCIe bridge. For example, in some embodiments, the PCI bridge 104 is configured to interface with the test device 102 via the at least one port 130 and provide a plurality of ports 132. For example, in some embodiments, the plurality of ports 132 of the PCI bridge 104 can include two, four, six, eight, or more ports. In some embodiments, the plurality of ports 132 can include universal serial bus (USB) ports or the like. It is to be appreciated that the type of USB ports (e.g., USB-A, USB-C, etc.) is not intended to be limited. Moreover, the generation of USB (i.e., USB 1.x, USB 2.0, USB 3.x, and USB 4) is not intended to be limited.

The hub device 106 is configured to be connected in communication to the PCI bridge 104 via the plurality of ports 132. As such, the hub device 106 includes at least one port 134. The hub device 106 also includes a plurality of ports 136. The plurality of ports 136 are configured to be connected to the plurality of DUTs 108 to enable communication between the test device 102 and the plurality of DUTs 108. In some embodiments, the hub device 106 can include varying numbers of plurality of ports 136. For example, in some embodiments, the plurality of ports 136 can include twenty (20) ports. In some embodiments, the plurality of ports 136 can include more or fewer than twenty ports. For example, in some embodiments, the plurality of ports 136 can include forty (40) ports. As a result, in some embodiments, up to forty plurality of DUTs 108 can be connected to and tested by the test device 102 at the same time.

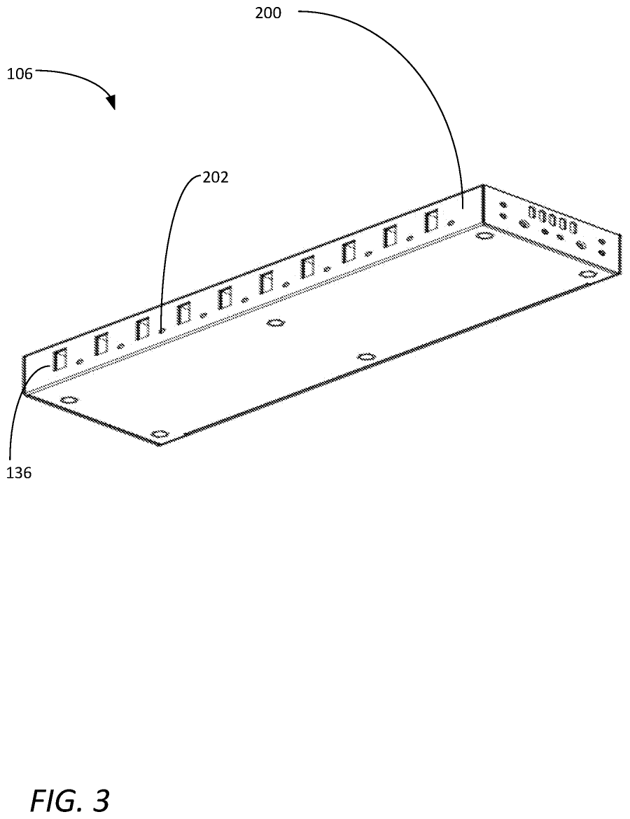

In some embodiments, two of the plurality of ports 136 can be connected to a one of the at least one port 134, and the respective one of the at least one port 134 can be connected to the PCI bridge 104 via one of the plurality of ports 132. In this manner, it is possible to provide an average bandwidth of 240 Mbps to each of the two of the plurality of ports 136. In some embodiments, the increase in bandwidth provided to each of the plurality of ports 136 can result in an increase of 80-200 units per hour (UPH) when testing the plurality of DUTs 108. This architecture is shown and described in additional detail in accordance with FIG. 3 below.

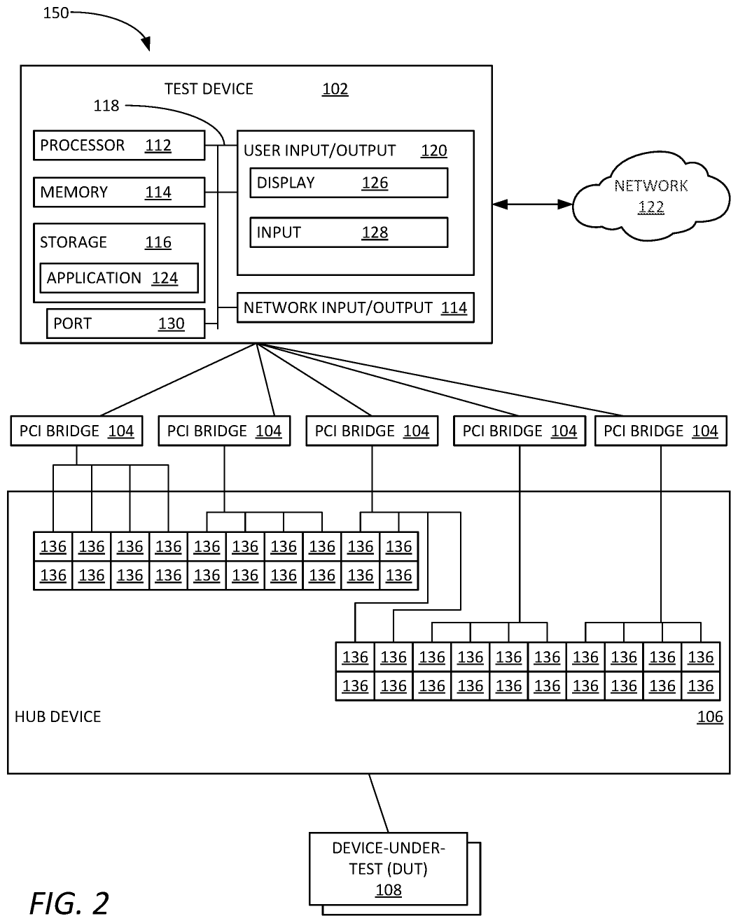

FIG. 2 shows a test system 150, according to some embodiments. The test system 150 includes the test system 102 having a plurality of the PCI bridges 104 connected and showing a plurality of connectors 152 connecting the PCI bridges 104 to the hub device 106. In some embodiments, each of the plurality of connectors 152 can be configured to provide an average bandwidth of 480 Mbps. It is to be appreciated that this number can vary beyond the stated value.

For simplicity of this Specification, features already discussed respective of FIG. 1 will not be described again in further detail.

In the illustrated embodiment, each PCI bridge 104 includes four of the plurality of connectors 152 connected to the hub device 106. Each of the plurality of connectors 152 is connected to a respective two of the plurality of ports 136. As a result, in the illustrated embodiment, the hub device 106 and the plurality of ports 136 includes forty ports, each of which can be connected to one of the plurality of DUTs 108. Additionally, the test system 150 includes five (5) of the PCI bridge 104. In some embodiments, the number of the plurality of connectors 152 for each PCI bridge 104 can be different. In such embodiments, the number of the PCI bridges 104 can vary beyond five. For example, the number of the PCI bridges 104 can be less than five or greater than five. Even in such embodiments, the number of the plurality of ports 136 connected to the plurality of connectors 152 can remain at two to enable sufficient bandwidths for each of the plurality of ports 136.

FIG. 3 shows the hub device 106, according to some embodiments. The hub device 106 includes a housing 200. Openings in the housing 200 are formed so that the plurality of ports 136 is accessible to be connected to respective of the plurality of DUTs 108. In some embodiments, the hub device 106 can include one or more outputs 202 on the housing 200 so that a user can quickly see a status of the respective of the plurality of DUTs 108.

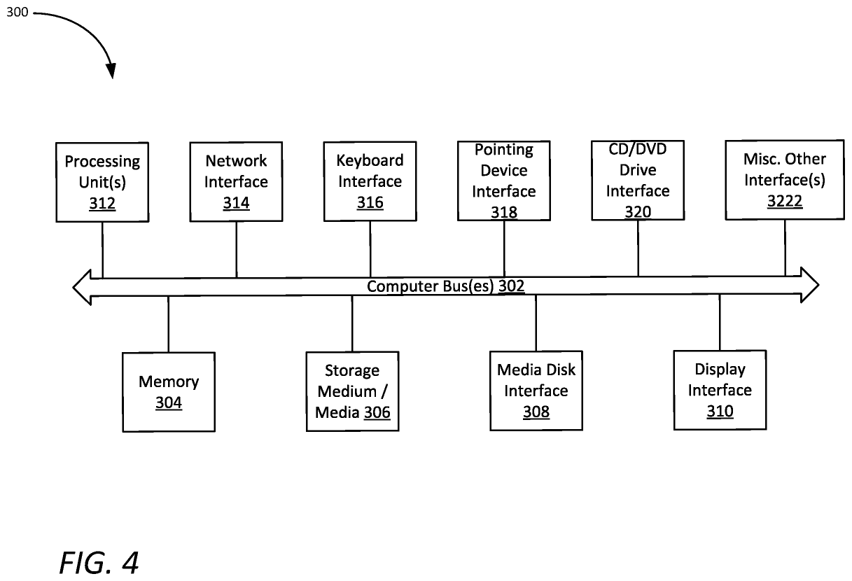

FIG. 4 is a block diagram illustrating an internal architecture 300 of an example of a computer, such as the test device 102 (FIG. 1; FIG. 2) or the one or more DUTs 108 (FIG. 1; FIG. 2), according to some embodiments. A computing device as referred to herein refers to any device with a processor capable of executing logic or coded instructions, and could be a server, personal computer, set top box, smart phone, pad computer or media device, to name a few such devices. As shown in the example of FIG. 4, internal architecture 300 includes one or more processing units (also referred to herein as CPUs) 280, which interface with at least one computer bus 302. Also interfacing with computer bus 302 are persistent storage medium/media 306, network interface 314, memory 304, e.g., random access memory (RAM), run-time transient memory, read only memory (ROM), etc., media disk drive interface 308 as an interface for a drive that can read and/or write to media including removable media such as floppy, CD ROM, DVD, etc. media, display interface 310 as interface for a monitor or other display device, keyboard interface 316 as interface for a keyboard, pointing device interface 318 as an interface for a mouse or other pointing device, CD/DVD drive interface 320, and miscellaneous other interfaces 322 not shown individually, such as parallel and serial port interfaces, a universal serial bus (USB) interface, and the like.

Memory 304 interfaces with computer bus 302 to provide information stored in memory 304 to CPU 312 during execution of software programs such as an operating system, application programs, device drivers, and software modules that comprise program code, and/or computer executable process operations, incorporating functionality described herein, e.g., one or more of process flows described herein. CPU 312 first loads computer executable process operations from storage, e.g., memory 304, storage medium/media 306, removable media drive, and/or other storage device. CPU 312 can then execute the stored process operations in order to execute the loaded computer-executable process operations. Stored data, e.g., data stored by a storage device, can be accessed by CPU 312 during the execution of computer-executable process operations.

Persistent storage medium/media 306 is a computer readable storage medium(s) that can be used to store software and data, e.g., an operating system and one or more application programs. Persistent storage medium/media 306 can also be used to store device drivers, such as one or more of a digital camera driver, monitor driver, printer driver, scanner driver, or other device drivers, web pages, content files, playlists and other files. Persistent storage medium/media 306 can further include program modules and data files used to implement one or more embodiments of the present disclosure.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers or be loaded and executed by one or more servers. One or more modules may be grouped into an engine or an application.

Examples of non-transitory computer-readable storage media include, but are not limited to, any tangible medium capable of storing a computer program for use by a programmable processing device to perform functions described herein by operating on input data and generating an output. A computer program is a set of instructions that can be used, directly or indirectly, in a computer system to perform a certain function or determine a certain result. Examples of non-transitory computer-readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing.

While this disclosure has described certain embodiments, it will be understood that the claims are not intended to be limited to these embodiments except as explicitly recited in the claims. On the contrary, the instant disclosure is intended to cover alternatives, modifications, and equivalents, which may be included within the spirit and scope of the disclosure. Furthermore, in the detailed description of the present disclosure, numerous specific details are set forth to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to convey the substance of their work most effectively to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data.

The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

In some embodiments, a device includes a housing. In some embodiments, the device includes a plurality of universal serial bus (USB) ports configured to be connected to a plurality of devices under test. In some embodiments, the plurality of USB ports is configured be connected to a connector in groups of two. In some embodiments, the respective connectors are configured to be connected to a peripheral communication interface (PCI) bridge.

In some embodiments, each of the plurality of USB ports has an average bandwidth of 240 megabits per second (Mbps).

In some embodiments, the device includes a plurality of outputs. In some embodiments, the plurality of outputs is configured to display a status indicator for a respective one of the plurality of USB ports.

In some embodiments, the plurality of USB ports includes 40 USB ports.

In some embodiments, the respective connectors includes 20 connectors configured to be connected to the respective PCI bridge.

In some embodiments, the respective connectors configured to be connected to the respective PCI bridge includes 4 connectors per PCI bridge.

In some embodiments, the respective connectors are configured to provide an average bandwidth of 480 Mbps.

In some embodiments, a system includes a test system; a peripheral communication interface (PCI) bridge; and a hub device. In some embodiments, the hub device includes a plurality of universal serial bus (USB) ports configured to be connected to a plurality of devices under test. In some embodiments, the plurality of USB ports is configured be connected to a connector in groups of two. In some embodiments, the respective connectors are configured to be connected to the PCI bridge.

In some embodiments, each of the plurality of USB ports has an average bandwidth of 240 megabits per second (Mbps).

In some embodiments, the hub device further includes a plurality of outputs. In some embodiments, the plurality of outputs is configured to display a status indicator for a respective one of the plurality of USB ports.

In some embodiments, the plurality of USB ports includes 40 USB ports.

In some embodiments, the PCI bridge includes a plurality of PCI bridges.

In some embodiments, the respective connectors include 20 connectors configured to be connected to respective ones of the plurality of PCI bridges.

In some embodiments, the respective connectors configure to the respective of the plurality of PCI bridges includes 4 connectors connected to the respective of the plurality of PCI bridges.

In some embodiments, the respective connectors are configured to provide an average bandwidth of 480 Mbps.

In some embodiments, a system includes a test system; a plurality of peripheral communication interface (PCI) bridges; and a hub device. In some embodiments, the hub device includes a plurality of universal serial bus (USB) ports configured to be connected to a plurality of devices under test. In some embodiments, the plurality of USB ports is configured be connected to a connector in groups of two. In some embodiments, the respective connectors are configured to be connected to the plurality of PCI bridges.

In some embodiments, the connector is configured to provide an average bandwidth of 480 megabits per second (Mbps).

In some embodiments, each of the plurality of USB ports has an average bandwidth of 240 megabits per second (Mbps).

In some embodiments, the hub device further includes a plurality of outputs. In some embodiments, the plurality of outputs is configured to display a status indicator for a respective one of the plurality of USB ports.

In some embodiments, the hub device includes 40 USB ports.

What is claimed is:

1. A device comprising:
a housing; and
a plurality of universal serial bus (USB) ports configured to be connected to a plurality of devices under test;
wherein the plurality of USB ports is configured be connected to a connector in groups of two,
wherein the respective connectors are configured to be connected to a peripheral communication interface (PCI) bridge.

2. The device of claim 1, wherein each of the plurality of USB ports has an average bandwidth of 240 megabits per second (Mbps).

3. The device of claim 1, further comprising a plurality of outputs, wherein the plurality of outputs is configured to display a status indicator for a respective one of the plurality of USB ports.

4. The device of claim 1, wherein the plurality of USB ports comprises 40 USB ports.

5. The device of claim 4, wherein the respective connectors comprises 20 connectors configured to be connected to the respective PCI bridge.

6. The device of claim 5, wherein the respective connectors configured to be connected to the respective PCI bridge includes 4 connectors per PCI bridge.

7. The device of claim 6, wherein the respective connectors are configured to provide an average bandwidth of 480 Mbps.

8. A system comprising:
a test system;
a peripheral communication interface (PCI) bridge; and
a hub device, comprising:
a plurality of universal serial bus (USB) ports configured to be connected to a plurality of devices under test;
wherein the plurality of USB ports is configured be connected to a connector in groups of two,
wherein the respective connectors are configured to be connected to the PCI bridge.

9. The system of claim 8, wherein each of the plurality of USB ports has an average bandwidth of 240 megabits per second (Mbps).

10. The system of claim 8, wherein the hub device further comprises a plurality of outputs, wherein the plurality of outputs is configured to display a status indicator for a respective one of the plurality of USB ports.

11. The system of claim 8, wherein the plurality of USB ports comprises 40 USB ports.

12. The system of claim 11, wherein the PCI bridge comprises a plurality of PCI bridges.

13. The system of claim 12, wherein the respective connectors comprise 20 connectors configured to be connected to respective ones of the plurality of PCI bridges.

14. The system of claim 13, wherein the respective connectors configure to the respective of the plurality of PCI bridges includes 4 connectors connected to the respective of the plurality of PCI bridges.

15. The system of claim 13, wherein the respective connectors are configured to provide an average bandwidth of 480 Mbps.

16. A system comprising:
a test system;
a plurality of peripheral communication interface (PCI) bridges; and
a hub device, comprising:
a plurality of universal serial bus (USB) ports configured to be connected to a plurality of devices under test;
wherein the plurality of USB ports is configured be connected to a connector in groups of two,
wherein the respective connectors are configured to be connected to the plurality of PCI bridges.

17. The system of claim 16, wherein the connector is configured to provide an average bandwidth of 480 megabits per second (Mbps).

18. The system of claim 16, wherein each of the plurality of USB ports has an average bandwidth of 240 megabits per second (Mbps).

19. The system of claim 16, wherein the hub device further comprises a plurality of outputs, wherein the plurality of outputs is configured to display a status indicator for a respective one of the plurality of USB ports.

20. The system of claim 16, wherein the hub device comprises 40 USB ports.
